(19) United States
(12) Patent Application Publication
(10) Pub. No.: US 2023/0231326 A1
(43) Pub. Date: Jul. 20, 2023

(54) ELECTRIC WIRE AND TERMINAL-EQUIPPED ELECTRIC WIRE

(71) Applicant: SUMITOMO WIRING SYSTEMS, LTD., Mie (JP)

(72) Inventors: Kenta KOBAYASHI, Mie (JP); Yusuke ARAKI, Mie (JP); Yuto HAYASHI, Mie (JP)

(21) Appl. No.: 18/011,283

(22) PCT Filed: Jun. 24, 2021
(86) PCT No.: PCT/JP2021/024039

§ 371 Date: Dec. 19, 2022

(30) Foreign Application Priority Data
Jun. 30, 2020 (JP) 2020-113460

(51) Int. Cl. H01R 4/18; H01B 5/08; H01R 4/02; H01B 7/18

(52) U.S. Cl. CPC H01R 4/18; H01B 5/08; H01R 4/023; H01B 7/18

(57) ABSTRACT

The present disclosure provides an electric wire including: a plurality of conductors that have been twisted together; and an insulation coating that covers an outer circumference of the plurality of conductors, wherein the plurality of conductors include: a plurality of outer conductors that are arranged along an outermost circumference; and at least one inner conductor that is provided on an inner side of the plurality of outer conductors, the at least one inner conductor includes one or more first strands, the one or more first strands are copper wires, each copper wire including a tin-plating layer, each of the plurality of outer conductors includes one or more second strands, and the one or more second strands are copper wires, each copper wire not including a plating layer.

### TECHNICAL FIELD

The present disclosure relates to an electric wire and a terminal-equipped electric wire.

The present application claims priority to Japanese Patent Application No. 2020-113460 filed on Jun. 30, 2020. The disclosure of the above-identified application is incorporated herein by reference in its entirety.

### BACKGROUND

Patent Document 1 discloses an electric wire that includes a twisted wire conductor and an insulation coating that is provided on an outer circumference of the twisted wire conductor. This twisted wire conductor is made using a concentric twisted wire formed by concentrically twisting a plurality of plated wires, each being composed of strands that each have a plating coating on the surface thereof. Plated wires that constitute an outermost layer of the concentric twisted wire are composed of strands, each having a silver-plating coating on the surface thereof. On the other hand, plated wires that constitute a layer on the inner side of the outermost layer of the concentric twisted wire are composed of strands, each having a tin-plating coating on the surface thereof.

### PRIOR ART DOCUMENT

### Patent Document

Patent Document 1: JP 2019-160668 A

### SUMMARY OF THE INVENTION

An electric wire according to the present disclosure is an electric wire including: a plurality of conductors that have been twisted together; and an insulation coating that covers an outer circumference of the plurality of conductors, wherein the plurality of conductors include: a plurality of outer conductors that are arranged along an outermost circumference; and at least one inner conductor that is provided on an inner side of the plurality of outer conductors, the at least one inner conductor includes one or more first strands, the one or more first strands are copper wires, each copper wire including a tin-plating layer, each of the plurality of outer conductors includes one or more second strands, and the one or more second strands are copper wires, each copper wire not including a plating layer.

A terminal-equipped electric wire according to the present disclosure includes the electric wire of the present disclosure and a terminal that is provided at an end portion of the electric wire.

### BRIEF DESCRIPTION OF THE DRAWINGS

FIG. 1 is a schematic cross-sectional view of an electric wire according to an embodiment.

FIG. 2 is a schematic cross-sectional view of an inner conductor included in the electric wire according to the embodiment.

FIG. 3 is a schematic cross-sectional view of an outer conductor included in the electric wire according to the embodiment.

FIG. 4 is a schematic diagram of a terminal-equipped electric wire according to an embodiment.

FIG. 5 is a schematic cross-sectional view of a terminal-equipped electric wire according to another aspect of the embodiment.

### DETAILED DESCRIPTION TO EXECUTE THE INVENTION

### Problems to be Solved by the Present Disclosure

It is desired that a contact resistance between an electric wire and a terminal is low when the terminal has been attached to a leading end of the electric wire. It is also desired that the contact resistance between the electric wire and the terminal remains low over time even in an environment in which cooling heating cycles occur. The contact resistance encompasses a contact resistance between strands that constitute the conductors and the terminal and a contact resistance between the strands. Specifically, in Patent Document 1, the contact resistance encompasses a contact resistance between the plated wires and the terminal and a contact resistance between the plated wires.

As with the technique disclosed in Patent Document 1, by configuring each strand to have a plating coating on the surface thereof, it is possible to prevent an oxide film from being formed on the surface of the strand, and suppress the increase in the contact resistance caused by the oxide film. However, a plating material and a plating process are additionally required to configure each strand to have a plating coating on the surface thereof, which results in a poor productivity and an increased production cost.

It is an object of the present disclosure to provide an electric wire and a terminal-equipped electric wire, with which it is possible to suppress an increase in the contact resistance between the electric wire and the terminal, and provide an excellent productivity.

### Advantageous Effects of the Present Disclosure

With the electric wire and the terminal-equipped electric wire according to the present disclosure, it is possible to suppress an increase in the contact resistance between the electric wire and the terminal, and provide an excellent productivity.

### Description of Embodiments of the Present Disclosure

First, aspects of an embodiment according to the present disclosure will be listed and described.

(1) An electric wire according to an aspect of the present disclosure is an electric wire including: a plurality of conductors that have been twisted together; and an insulation coating that covers an outer circumference of the plurality of conductors, wherein the plurality of conductors include: a plurality of outer conductors that are arranged along an outermost circumference; and at least one inner conductor that is provided on an inner side of the plurality of outer conductors, the at least one inner conductor includes one or more first strands, the one or more first strands are copper wires, each copper wire including a tin-plating layer, each of the plurality of outer conductors includes one or more second strands, and the one or more second strands are copper wires, each copper wire not including a plating layer.

When attaching a terminal to a leading end of the electric wire, the insulation coating is removed at the leading end of the electric wire to expose the conductors, and the terminal is connected to the exposed conductors. When the terminal has been attached to the leading end of the electric wire, the outer conductors come into direct contact with the terminal. The contact resistance between the electric wire and the terminal encompasses a contact resistance between the outer conductors and the terminal, a contact resistance between the outer conductors, and a contact resistance between the outer conductors and the inner conductor. In the case where the inner conductor is composed of a plurality of inner conductors, the contact resistance between the electric wire and the terminal also encompasses a contact resistance between the inner conductors.

As a result of the outer conductors coming into direct contact with the terminal, even when an oxide film is formed on the surface of each second strand, the oxide film is likely to be broken at the time of attaching the terminal. Also, a load is likely to be applied to the outer conductors from the terminal due to vibration during use of the electric wire, and thus the oxide film is likely to be broken. Accordingly, the outer conductors do not substantially affect the contact resistance between the electric wire and the terminal. On the other hand, the inner conductor does not come into direct contact with the terminal, and thus even when an oxide film is formed on the surface of each first strand, the oxide film is unlikely to be broken at the time of attaching the terminal and also over time. In particular, in the inner conductor, spaces are likely to be formed between the first strands, and thus oxide films are likely to be formed on the surfaces of the first strands. Accordingly, the inner conductor significantly affects the contact resistance between the electric wire and the terminal. That is, an increase in the contact resistance between the electric wire and the terminal is mainly caused by the inner conductor. In the electric wire of the present disclosure, the first strands and the second strands are copper wires. Accordingly, the contact resistance between the outer conductors and contact resistance between the inner conductors do not affect the increase in the contact resistance between the electric wire and the terminal. For this reason, in the following description, in the contact resistance between the electric wire and the terminal, the contact resistance between the outer conductors and contact resistance between the inner conductors are ignored.

In the electric wire of the present disclosure, the second strands that constitute the outer conductors are copper wires without plating layers. Even when the second strands do not include plating layers, an increase in the contact resistance between the electric wire and the terminal is suppressed by the second strands coming into direct contact with the terminal. By configuring the second strands not to have plating layers, it is possible to omit a portion of the plating process, improve the productivity, and reduce the production cost. Also, by configuring the second strands not to have plating layers, when attaching the terminal to the leading end of the electric wire, the scrap pieces of the tin-plating layers are unlikely to be released to the outside, and thus the adverse effect on the processing environment can be suppressed.

In the electric wire of the present disclosure, the first strands that constitute the inner conductors are copper wires with tin-plating layers. By configuring the first strands to have tin-plating layers, oxide layers are unlikely to be formed on the surfaces of the first strands, and thus the increase in the contact resistance between the first strands caused by the oxide films can be suppressed. In particular, the plating layers are tin-plating layers, and thus the production cost can be reduced as compared with the case where the plating layers are silver plating layers or the like.

From the above, the electric wire of the present disclosure includes the first strands with plating layers, and it is therefore possible to suppress an increase in the contact resistance between the first strands when the terminal has been attached to the leading end of the electric wire, and eventually suppress an increase in the contact resistance between the electric wire and the terminal. Also, the electric wire of the present disclosure includes the first strands with plating layers, and it is therefore possible to suppress an increase in the contact resistance between the first stands even in an environment in which cooling heating cycles occur, and eventually suppress an increase in the contact resistance between the electric wire and the terminal over time. The electric wire of the present disclosure includes the second strands without plating layers, and thus an excellent productivity can be obtained.

(2) As an example of the electric wire of the present disclosure, the at least one inner conductor may include the plurality of first strands that have been twisted together, and each of the plurality of outer conductors may include the plurality of second strands that have been twisted together.

With the configuration described above, the electric wire includes the plurality of first strands and the plurality of second strand, and it is therefore possible to cause a large current to flow through the conductors. As described above, with the electric wire of the present disclosure, it is possible to suppress an increase in the contact resistance between the electric wire and the terminal over time. Accordingly, even when a large current flows through the conductors, the power loss is small. With the configuration described above, the electric wire of the present disclosure can be suitably used as a power cable that connects a battery and an inverter in a vehicle or a power cable that connects an inverter and a motor.

(3) As an example of the electric wire of the present disclosure, the at least one inner conductor may include the one first strand, and each of the plurality of outer conductors may include the one second strand.

With the configuration described above, the number of strands is small, and thus the electric wire can be lightweight. With the configuration described above, the electric wire of the present disclosure can be suitably used as a small-diameter electric wire used in an in-wheel motor or the like.

(4) As an example of the electric wire of the present disclosure, the first strands and the second strands may have a diameter of 0.30 mm or more.

With the configuration described above, the contact area between the first strands and the second strands, the contact area between the first strands, and the contact area between the second strands can be sufficiently ensured. As a result of these contact areas being large, an increase in the contact resistance between the electric wire and the terminal over time can be easily suppressed. In particular, as a result of the contact area between the first strands being large, an increase in the contact resistance between the first strands can be easily suppressed, and an increase in the contact resistance between the electric wire and the terminal can be effectively suppressed.

(5) A terminal-equipped electric wire according to an aspect of the present disclosure includes the electric wire according to any one of (1) to (4) described above and a terminal that is provided at an end portion of the electric wire.

The terminal-equipped electric wire of the present disclosure includes the electric wire of the present disclosure, and it is therefore possible to suppress an increase in the contact resistance between the electric wire and the terminal when the terminal has been attached to the leading end of the electric wire. Also, the terminal-equipped electric wire of the present disclosure includes the electric wire of the present disclosure, and it is therefore possible to suppress an increase in the contact resistance between the electric wire and the terminal over time even in an environment in which cooling heating cycles occur. Furthermore, the terminal-equipped electric wire of the present disclosure includes the electric wire of the present disclosure, and thus an excellent productivity can be obtained.

(6) As an example of the terminal-equipped electric wire of the present disclosure, the terminal may be a crimp terminal.

The crimp terminal can be easily attached to the leading end of the electric wire by means of a mechanical connection. When crimping the terminal to the leading end of the electric wire, the compression rate varies depending on the diameter of the strands. For example, in the case where the strands have a small diameter, it is necessary to set a small compression rate that does not break the strands. With the configuration described above, the terminal-equipped electric wire includes the electric wire of the present disclosure, and thus even when the terminal is crimped at a small compression rate that does not break the small-diameter strands, an increase in the contact resistance between the electric wire and the terminal can be suppressed.

(7) As an example of the terminal-equipped electric wire of the present disclosure, the terminal-equipped electric wire may include a solder portion that is provided at the end portion of the electric wire, and the solder portion may be embedded in gaps between the strands at the end portion of the electric wire.

With the configuration described above, the solder portion is embedded between the strands, and thus the contact resistance between the electric wire and the terminal can be easily reduced. In particular, as a result of the first strands including the tin-plating layers, the solder portion can be easily embedded in the gaps between the first strands due to a capillary action.

### Detailed Description of Embodiments of the Present Disclosure

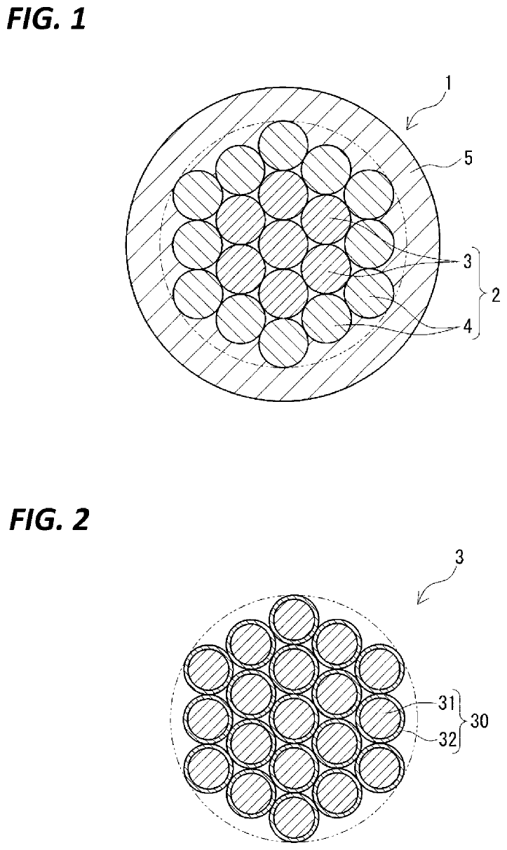

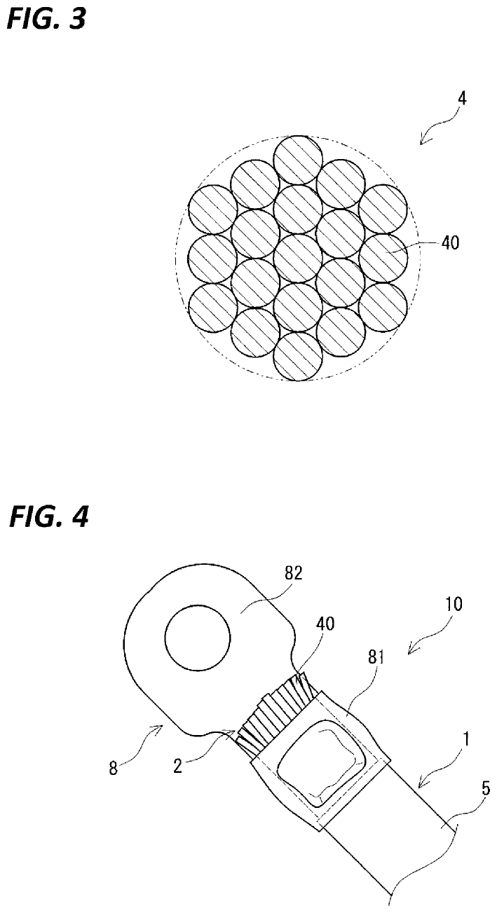

Embodiments of the present disclosure will be described below in detail with reference to the drawings. FIG. 1 is a cross-sectional view of an electric wire 1 taken along a direction perpendicular to the lengthwise direction of the electric wire 1. This cross section will be referred to as a “transverse cross section”. In FIG. 1, individual inner conductors 3 and outer conductors 4 that constitute conductors 2 are simply indicated by circles. In FIG. 1, a contour surrounding the plurality of conductors 2 is indicated by a dashed-double-dotted line. FIG. 2 shows one of the inner conductors 3 shown in FIG. 1. In FIG. 2, a contour surrounding a plurality of first strands 30 is indicated by a dashed-double-dotted line. FIG. 3 shows one of the outer conductors 4 shown in FIG. 1. In FIG. 3, a contour surrounding a plurality of second strands 40 is indicated by a dashed-double-dotted line. In the diagrams, the same reference numerals indicate the same components.

(Electric Wire)

As shown in FIG. 1, the electric wire 1 according to an embodiment includes a plurality of conductors 2 that have been twisted together and an insulation coating 5 that covers the outer circumference of the plurality of conductors 2. The plurality of conductors 2 include a plurality of outer conductors 4 that are arranged along the outermost circumference and at least one inner conductor 3 that is provided on the inner side of the plurality of outer conductors 4. The conductors 2 in this example include a plurality of inner conductors 3. As shown in FIG. 2, an inner conductor 3 includes one or more first strands 30. As shown in FIG. 3, each outer conductor 4 includes one or more second strands 40. As used herein, the term “the outermost circumference of the conductors 2” refers to the most outer boundary of the conductors 2 that have been twisted together in the circumferential direction of the electric wire 1. A feature of the electric wire 1 according to the embodiment is that the one or more first strands 30 are copper wires that each include a tin-plating layer 32 (FIG. 2), and the one or more second strands 40 are copper wires that each does not include a plating layer (FIG. 3). Hereinafter, the structural elements will be described in detail one by one.

((Conductor))

The conductors 2 include at least one inner conductor 3 and a plurality of outer conductors 4. As shown in FIG. 1, the conductors 2 in this example include a plurality of inner conductors 3 and a plurality of outer conductors 4. The conductors 2 in this example include seven inner conductors 3 and twelve outer conductors 4. The inner conductors 3 in this example are formed by twisting six inner conductors 3 together around one inner conductor 3 that is provided at the center. The outer conductors 4 are formed by twisting twelve outer conductors 4 together around the plurality of inner conductors 3 that have been twisted together. That is, the conductors 2 in this example have a three-layer structure that includes a first layer, a second layer, and a third layer in this order from the center. The first layer and the second layer are formed by the plurality of inner conductors 3, and the third layer is formed by the plurality of outer conductors 4. Among the conductors 2, the plurality of outer conductors 4 that constitute the third layer come into direct contact with a terminal 8 (FIG. 4). The number of inner conductors 3 and the number of outer conductors 4 can be selected as appropriate.

The twist pitch of the inner conductors 3 and the twist pitch of the outer conductors 4 can be selected as appropriate. The twist pitch of the inner conductors 3 may be, for example, 20 mm or more and 120 mm or less, or 30 mm or more and 70 mm or less. The twist pitch of the outer conductors 4 may be, for example, 20 mm or more and 120 mm or less, or 30 mm or more and 70 mm or less. By setting the twist pitch of the inner conductors 3 and the twist pitch of the outer conductors 4 to be greater than or equal to the above-described lower limit values, the conductors can be easily twisted together, and the productivity of the electric wire 1 can be improved. On the other hand, by setting the twist pitch of the inner conductors 3 and the twist pitch of the outer conductors 4 to be less than or equal to the above-described upper limit values, the bendability of the electric wire 1 can be improved.

[Inner Conductor]

Each of the inner conductors 3 is composed of one or more first strands 30. As shown in FIG. 2, an inner conductor 3 in this example is composed of a plurality of first strands 30. The plurality of first strands 30 are twisted together. Specifically, the inner conductor 3 in this example is formed by arranging six first strands 30 around the outer circumference of one first strand 30 that is provided at the center, and then, arranging twelve first strands 30 around the six first strands 30 in this order from the inside toward the outside of the one first strand 30 that is provided at the center, and twisting these first strands 30 together. The number of first strands 30 can be selected as appropriate. The inner conductor 3 may be composed of a single first strand 30.

The twist pitch of the first strands 30 can be selected as appropriate. The twist pitch of the first strands 30 may be, for example, 10 mm or more and 100 mm or less, or 30 mm or more and 60 mm or less. By setting the twist pitch of the first strands 30 to be greater than or equal to the above-described lower limit value, the strands can be easily twisted together, and the productivity of the electric wire 1 can be improved. On the other hand, by setting the twist pitch of the first strands 30 to be less than or equal to the above-described upper limit value, the bendability of the electric wire 1 can be improved.

Each of the first strands 30 includes a core portion 31 and a tin-plating layer 32 that covers the outer circumference of the core portion 31. The core portion 31 may be made of pure copper such as tough pitch copper or oxygen-free copper. The copper purity is preferably 99.90 mass % or more, and more preferably 99.99 mass % or more. The first strands 30 may be tin-plated annealed copper wires specified in accordance with JIS C 3152 (1984). In the case where each of the inner conductors 3 is composed of a plurality of first strands 30, all of the first strands 30 are copper wires that each have a tin-plating layer 32.

Each of the first strands 30 may have a diameter of 0.08 mm or more and 0.51 mm or less. When each of the first strands 30 has a diameter of 0.08 mm or more, the contact area between the first strands 30 can be increased. When the contact area between the first strands 30 is large, it is possible to suppress an increase in the contact resistance between the first strands 30, and eventually suppress an increase in the contact resistance between the electric wire 1 and the terminal 8 (FIG. 4). On the other hand, when each of the first strands 30 has a diameter of 0.51 mm or less, an increase in the diameter of the first strand 30 can be suppressed. In particular, when each of the first strands 30 has a diameter of 0.30 mm or more, a sufficiently large contact area between the first strands 30 can be ensured. Each of the first strands 30 may have a diameter of 0.30 mm or more and 0.51 mm or less, 0.30 mm or more and 0.45 mm or less, or 0.30 mm or more and 0.32 mm or less. Each of the first strands 30 may have a diameter of 0.08 mm or more and less than 0.30 mm, 0.08 mm or more and 0.12 mm or less, or 0.10 mm or more and 0.12 mm or less.

In the case where each of the inner conductors 3 is composed of a plurality of first strands 30, all of the first strands 30 may have the same diameter. In this case, the first strands 30 can be easily prepared. In the case where each of the inner conductors 3 is composed of a plurality of first strands 30, a plurality of different types of first strands 30 that have different diameters may also be used. In this case, depending on the diameters of the first strands 30, the spaces between the first strands 30 can be made small.

The tin-plating layer 32 of each of the first strands 30 may have a transverse cross-sectional thickness of 1 μm or more and 20 μm or less. When the transverse cross-sectional thickness of the tin-plating layer 32 is 1 μm or more, oxidation of the core portion 31 can be easily prevented. On the other hand, when the transverse cross-sectional thickness of the tin-plating layer 32 is 20 μm or less, the amount of plating material can be reduced. The transverse cross-sectional thickness of the tin-plating layer 32 may be 1 μm or more and 15 μm or less, or 1 μm or more and 10 μm or less. The transverse cross-sectional thickness of the tin-plating layer 32 is an average thickness obtained based on a measurement method described below. In a transverse cross section of the electric wire 1, three or more first strands 30 are randomly selected. In each of the first strands 30, three or more measurement points are selected equidistantly in the circumferential direction, and the thickness of the tin-plating layer 32 is measured at each measurement point. An average value of the thicknesses measured at the measurement points in all of the selected first strands 30 is determined. The determined average thickness is used as the thickness of the tin-plating layer 32.

The inner conductor 3 may have a transverse cross-sectional area of 0.7 mm² or more and 5.7 mm² or less, or 1.5 mm² or more and 5.7 mm² or less. The transverse cross-sectional area of the inner conductor 3 can be considered as the total transverse cross-sectional area of the first strands 30.

[Outer Conductor]

Each of the outer conductors 4 is composed of one or more second strands 40. As shown in FIG. 3, an outer conductor 4 in this example is composed of a plurality of second strands 40. The plurality of second strands 40 are twisted together. Specifically, each outer conductor 4 in this example is formed by arranging six second strands 40 around the outer circumference of one second strand 40 that is provided at the center, and then, arranging twelve second strands 40 around the six second strands 40 in this order from the inside toward the outside of the one second strand 40 that is provided at the center, and twisting these second strands 40 together. The number of second strands 40 can be selected as appropriate. Each of the outer conductors 4 may be composed of a single second strand 40.

The twist pitch of the second strands 40 can be selected as appropriate. The twist pitch of the second strands 40 may be, for example, 10 mm or more and 100 mm or less, or 30 mm or more and 60 mm or less. By setting the twist pitch of the second strands 40 to be greater than or equal to the above-described lower limit value, the strands can be easily twisted together, and the productivity of the electric wire 1 can be improved. On the other hand, by setting the twist pitch of the second strands 40 to be less than or equal to the above-described upper limit value, the bendability of the electric wire 1 can be improved.

Each of the second strands 40 is a bare copper wire made of pure copper or the like without a plating layer. That is, each of the second strands 40 is composed only of a region that corresponds to the core portion 31 of the first strand 30 (FIG. 2). In the case where each of the outer conductors 4 is composed of a plurality of second strands 40, all of the second strands 40 are copper wires without plating layers.

Each of the second strands 40 may have a diameter of 0.08 mm or more and 0.51 mm or less. When each of the second strands 40 has a diameter of 0.08 mm or more, the contact area between the second strands 40 and the contact area between the second strands 40 and the terminal 8 (FIG. 4) can be increased. When these contact areas are large, the electrical connection between the electric wire 1 and the terminal 8 can be easily ensured. On the other hand, when each of the second strands 40 has a diameter of 0.51 mm or less, an increase in the diameter of the second strand 40 can be suppressed. In particular, when each of the second strands 40 has a diameter of 0.30 mm or more, a sufficiently large contact area between the second strands 40 and a sufficiently large contact area between the second strands 40 and the terminal 8 can be ensured. Each of the second strands 40 may have a diameter of 0.30 mm or more and 0.51 mm or less, 0.30 mm or more and 0.45 mm or less, or 0.30 mm or more and 0.32 mm or less. Each of the second strands 40 may have a diameter of 0.08 mm or more and less than 0.30 mm, 0.08 mm or more and 0.12 mm or less, or 0.10 mm or more and 0.12 mm or less.

In the case where each of the outer conductors 4 is composed of a plurality of second strands 40, all of the second strands 40 may have the same diameter. In this case, the second strands 40 can be easily prepared. In the case where each of the outer conductors 4 is composed of a plurality of second strands 40, a plurality of different types of second strands 40 that have different diameters may also be used. In this case, depending on the diameters of the second strands 40, the spaces between the second strands 40 can be made small. The diameter of a second strand 40 may be the same as or different from the diameter of a first strand 30.

The outer conductor 4 may have a transverse cross-sectional area of 0.7 mm² or more and 5.7 mm² or less, or 1.5 mm² or more and 5.7 mm² or less. The transverse cross-sectional area of the outer conductor 4 can be considered as the total transverse cross-sectional area of the second strands 40.

[Cross-Sectional Area of Conductor]

The transverse cross-sectional area of the conductors 2 can be considered as the total area of the total transverse cross-sectional area of the inner conductors 3 and the total transverse cross-sectional area of the outer conductors 4. The transverse cross-sectional area of the conductors 2 can be selected as appropriate according to the application, the specifications, and the like.

The transverse cross-sectional shape of each of the conductors 2, the inner conductors 3, and the outer conductors 4 can be selected as appropriate. FIGS. 1 to 3 show a twisted shape, but the conductors 2, the inner conductors 3, and the outer conductors 4 may be compressed assemblies obtained through compression molding, or the like. The transverse cross-sectional shape of a compressed assembly may be circular, elliptic, polygonal such as rectangular, or the like. As used herein, the term “transverse cross-sectional shape” refers to a shape that is surrounded by a dashed-double-dotted line in FIGS. 1 to 3.

((Insulation Coating))

The insulation coating 5 is made using a resin that has insulation, flexibility, heat resistance, water resistance, and the like. The insulation coating 5 is typically made using polyvinyl chloride (PVC), polyethylene, cross-linked polyethylene (PE), or the like. The thickness of the insulation coating 5 can be selected as appropriate mainly according to the insulation properties required for the voltage of the conductors 2. Extrusion molding can be suitably used to mold the insulation coating 5.

(Terminal-Equipped Electric Wire)

As shown in FIG. 4, a terminal-equipped electric wire 10 according to an embodiment includes the above-described electric wire 1 and a terminal 8 that is provided at an end portion of the electric wire 1. The electric wire 1 is cut into an appropriate length, and the insulation coating 5 is removed at the leading end of the electric wire 1 to expose the conductors 2. The terminal 8 is connected to the exposed conductors 2 of the electric wire 1. The terminal 8 is typically a crimp terminal as shown in FIG. 4. The crimp terminal can be easily attached to the leading end of the electric wire 1 by means of a mechanical connection. For example, as shown in FIG. 4, the terminal 8 may include a tubular wire barrel portion 81 and a flat plate-shaped connection portion 82 that extends from the wire barrel portion 81. The terminal-equipped electric wire 10 in this example is formed by inserting end portions of the conductors 2 into the wire barrel portion 81 and crimping the conductors 2 and the wire barrel portion 81 together. The connection portion 82 includes a through hole through which a fastening member such as a bolt is inserted. The terminal 8 may be, other than a crimp terminal, a weld-type terminal that is attached through welding such as ultrasonic welding.

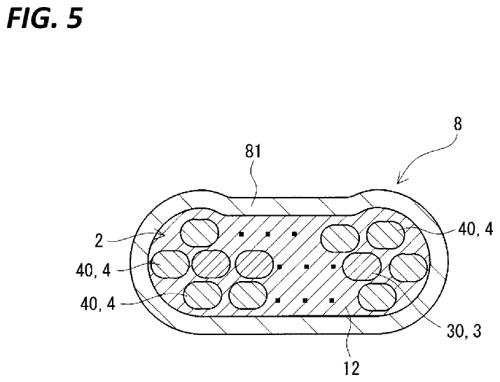

As shown in FIG. 5, the terminal-equipped electric wire 10 may further include a solder portion 12 at the end portion of the electric wire 1. FIG. 5 is a cross-sectional view of the terminal-equipped electric wire 10 taken along a direction perpendicular to the lengthwise direction of the terminal-equipped electric wire 10, showing a portion where the conductors 2 and the wire barrel portion 81 have been crimped together. For the sake of convenience of the description, FIG. 5 shows a portion of the first strands 30 and the second strands 40. In FIG. 5, for the sake of simplification, the tin-plating layers 32 of the first strands 30 are not illustrated. For the sake of convenience of the description, in FIG. 5, the gaps between the first strands 30, the gaps between the second strands 40, and the gaps between the first strands 30 and the second strands 40 are shown in an exaggerated manner At the end of the electric wire 1, the solder portion 12 is embedded in the gaps between the first strands 30, the gaps between the second strands 40, and the gaps between the first strands 30 and the second strands 40. In particular, the first strands 30 include the tin-plating layers 32, and thus the solder portion 12 can be easily embedded in the gaps between the first strands 30 due to a capillary action. As a result of the solder portion 12 being embedded in the gaps between strands 30 and the gaps between strands 40, the contact resistance between the electric wire 1 and the terminal 8 can be easily reduced. The solder portion 12 is not essential.

### Advantageous Effects

With the electric wire 1 of the embodiment and the terminal-equipped electric wire 10 of the embodiment, it is possible to suppress an increase in the contact resistance between the electric wire 1 and the terminal 8. The first reason that an increase in the contact resistance between the electric wire 1 and the terminal 8 can be suppressed is that, even when the second strands 40 that constitute an outer conductor 4 are copper wires without plating layers, the second strands 40 can come into direct contact with the terminal 8. As a result of the second strands 40 coming into direct contact with the terminal 8, even when oxide films are formed on the surfaces of the second strands 40, the oxide films are likely to be broken due to the terminal 8 being crimped. Also, as a result of the second strands 40 coming into direct contact with the terminal 8, even when oxide films are formed on the surfaces of the second strands 40, a load is likely to be applied from the terminal 8 due to vibration during use of the electric wire 1, and thus the oxide films are likely to be broken. The second reason that an increase in the contact resistance between the electric wire 1 and the terminal 8 can be suppressed is that the first strands 30 that constitute an inner conductor 3 include tin-plating layers 32, and thus oxide films are unlikely to be formed on the surfaces of the first strands 30.

The electric wire 1 of the embodiment and the terminal-equipped electric wire 10 of the embodiment provide an excellent productivity. The reason that they can provide an excellent productivity is that the second strands 40 do not include plating layers, and thus a portion of the plating process can be omitted. By omitting a portion of the plating process, it is also possible to reduce the production cost.

In the electric wire 1 of the embodiment and the terminal-equipped electric wire 10 of the embodiment, it is possible to use strands with a diameter as small as 0.08 mm or more and less than 0.30 mm. This is because, with the electric wire 1 of the embodiment and the terminal-equipped electric wire 10 of the embodiment, even when the terminal is crimped at a small compression rate that does not break the above-described small-diameter strands, as described above, an increase in the contact resistance between the electric wire 1 and the terminal 8 can be suppressed. With the electric wire 1 of the embodiment and the terminal-equipped electric wire 10 of the embodiment, an increase in the contact resistance between the electric wire 1 and the terminal 8 can be suppressed irrespective of the diameters of the strands 30 and 40.

In the electric wire 1 of the embodiment and the terminal-equipped electric wire 10 of the embodiment, whether the strands 30 are bonded to each other through soldering and whether the strands 40 are bonded to each other through soldering do not matter. In the electric wire 1 of the embodiment and the terminal-equipped electric wire 10 of the embodiment, even when both the strands 30 and the strands 40 are not bonded to each other through soldering, as described above, an increase in the contact resistance between the electric wire 1 and the terminal 8 can be suppressed. Of course, as shown in FIG. 5, the strands 30 and the strands 40 may be bonded to each other through soldering. In this case, because the first strands 30 include the tin-plating layers 32, the solder portion 12 can be easily embedded in the gaps between the first strands 30 due to a capillary action.

### TEST EXAMPLE

Electric wires including conductors formed by twisting a plurality of strands together were produced, and a terminal was attached to the leading end of each electric wire. Then, the adhesion strength between the electric wire and the terminal, and the contact resistance between the electric wire and the terminal were measured.

(Test Piece)

[Sample No. 1]

As sample No. 1, seven inner conductors and twelve outer conductors were used to form conductors. Specifically, the conductors were formed by arranging six inner conductors around the outer circumference of one inner conductor provided at the center, twisting together the six inner conductors, and then, arranging twelve inner conductors around the outer circumference of the six inner conductors, and twisting the twelve outer conductors together (see FIG. 1).

Each inner conductor was formed by twisting nineteen first strands together. Specifically, each inner conductor was formed by arranging six first strands around the outer circumference of one first strand that was provided at the center, and then, arranging twelve first strands around the six first strands in this order from the inside toward the outside of the one first strand that was provided at the center, and twisting these first strands together. Each first strand was a copper wire with a tin-plating layer. Each first strand had a diameter of 0.32 mm. The transverse cross-sectional thickness of the tin-plating layer of the first strand was 1.0 μm. Each inner conductor had a transverse cross-sectional area of 1.52 mm².

Each outer conductor was formed by twisting nineteen second strands together. Specifically, each outer conductor was formed by arranging six second strands around the outer circumference of one second strand that was provided at the center, and then, arranging twelve second strands around the six second strands in this order from the inside toward the outside of the one second strand that was provided at the center, and twisting these second strands together. Each second strand was a copper wire without a plating layer. Each second strand had a diameter of 0.32 mm. Each outer conductor had a transverse cross-sectional area of 1.52 mm².

The cross-sectional area of the obtained conductors was 30 mm².

An electric wire was produced by forming an insulation coating made of cross-linked polyethylene around the outer circumference of the obtained conductors. The insulation coating had a thickness of 1.4 mm.

At the leading end of the produced electric wire, the insulation coating was removed to expose the conductors, and a crimp terminal was crimped to the exposed conductors (see FIG. 4). As the crimp terminal, a known copper crimp terminal with a nickel plating layer was used. The compression rate was 75%.

[Sample No. 2]

As sample No. 2, a terminal-equipped electric wire was produced in the same manner as that of sample No. 1, except that copper wires without plating layers were used as the first strands for constituting an inner conductor and the second strands for constituting an outer conductor.

[Sample No. 3]

As sample No. 3, a terminal-equipped electric wire was produced in the same manner as that of sample No. 1, except that copper wires with tin-plating layers were used as the first strands for constituting an inner conductor and the second strands for constituting an outer conductor.

(Adhesion Strength)

In the terminal-equipped electric wire of each sample, the adhesion strength of the terminal was measured. As the adhesion strength, a maximum load at break of the terminal was measured by pulling the terminal at a rate of 100 mm/min using a general-purpose tensile testing machine. As used herein, the term “break of the terminal” may be either one of the following cases: the terminal itself was broken; and the terminal came off from the conductors. The maximum load is expressed in the unit of N. This maximum load is defined as the adhesion strength of the terminal. For each sample, the measurement was performed 30 times to obtain the average value of the measured values. The results are shown in Table 1.

(Initial Contact Resistance)

In the terminal-equipped electric wire of each sample, the contact resistance between the electric wire and the terminal when the terminal had been attached to the leading end of the electric wire was measured. The contact resistance was measured in accordance with Testing Method for Conductor-Resistance and Resistivity of Metallic Resistance Materials specified in JIS C 2525. Specifically, an electric wire sample with a length of 500 mm was used to measure the contact resistance. A terminal was crimped to one end portion of the electric wire sample, and the insulating coating was removed at the other end portion of the electric wire sample. The terminal that had been crimped to the one end portion and the conductors from which the insulation coating had been removed were clamped using a clamp of a measurement device. In this state, an electrical resistance value was measured. The contact resistance between the wire barrel portion of the terminal and the conductors was obtained by subtracting a measured value of a reference sample measured in advance from the measured electrical resistance value. The contact resistance between the electric wire and the terminal was obtained by measuring the contact resistance of the terminal-equipped electric wire and the contact resistance of the electric wire without the terminal being attached, and then calculating the difference therebetween. The results are shown in Table 1.

(Contact Resistance after Cooling Heating Cycles)

In the terminal-equipped electric wire of each sample, the contact resistance between the electric wire and the terminal when the terminal-equipped electric wire was left in a cooling heating environment for a predetermined length of time was measured. The cooling heating environment is an environment in which the temperature is alternately changed between −40° C. and 120° C. An operation of holding the temperature at −40° C. for 30 minutes and then holding the temperature at 120° C. for 30 minutes is defined as one cycle. The predetermined length of time is a length of time during which 1000 cycles are performed, with one cycle requiring one hour. The method for measuring the contact resistance is the same as the method for measuring the initial contact resistance. The results are shown in Table 1.

TABLE 1

| | | | Contact resistance |
|---|---|---|---|
| | | Initial contact | after cooling |
| Sample | Adhesion strength | resistance | heating cycles |
| No. | (N) | (mV/A) | (mV/A) |
| 1 | 4,008 | 0.0185 | 0.0278 |
| 2 | 4,096 | 0.0192 | 0.1430 |
| 3 | 3,996 | 0.0182 | 0.0234 |

As shown in Table 1, it can be seen that, in sample No. 1 in which copper wires with tin-plating layers were used as the first strands, and copper wires without plating layers were used as the second strands, an excellent adhesion strength was obtained, and the initial contact resistance and the contact resistance after cooling heating cycles were both small. The initial contact resistance and the contact resistance after cooling heating cycles of sample No. 1 were about the same as those of sample No. 3 in which copper wires with tin-plating layers were used as the first strands and the second strands. The reason that the initial contact resistance and the contact resistance after cooling heating cycles of sample No. 3 were small is considered to be that, as a result of the strands each having a tin-plating layer, an oxide film was unlikely to be formed on the surface of each strand, and it was therefore possible to suppress an increase in the contact resistance between the strands. The reason that the initial contact resistance and the contact resistance after cooling heating cycles of sample No. 1 were small is considered to be that, as a result of the first strands provided on the inner side each including a tin-plating layer, an oxide film was unlikely to be formed on the surface of the first strand, and it was therefore possible to suppress an increase in the contact resistance between the first strands. In sample No. 1, the second strands provided on the outer side do not include plating layers. When the second strands do not include plating layers, oxide films may be formed on the surfaces of the second strands. However, in sample No. 1, it is considered that, as a result of the second strands coming into direct contact with the terminal, a load is applied from the terminal at the time of crimping the terminal and also over time, and thus the oxide films are broken, and it was therefore possible to suppress the increase in the contact resistance caused by the second strands. Excellent productivity was obtained in sample No. 1 in which the second strands did not include plating layers, as compared with sample No. 3.

On the other hand, it can be seen that, in sample No. 2, in which copper wires without plating layers were used as the first strands and the second strands, the initial contact resistance was slightly large, and the contact resistance after cooling heating cycles was very large. The reason that the initial contact resistance and the contact resistance after cooling heating cycles of sample No. 2 were large is considered to be that, as a result of the strands not including tin-plating layers, an oxide film was formed on the surface of each strand, which increased the contact resistance between the strands.

The present invention is not limited to examples given above, the scope of the present invention is indicated by the appended claims, and all changes that come within the meaning and range of equivalency of the claims are intended to be embraced within the scope of the present invention.

### LIST OF REFERENCE NUMERALS

1 Electric wire

2 Conductor

3 Inner conductor

30 First strand

31 Core portion

32 Tin-plating layer

4 Outer conductor

40 Second strand

5 Insulation coating

8 Terminal

81 Wire barrel portion

82 Connection portion

10 Terminal-equipped electric wire

12 Solder portion

1. An electric wire comprising:
a plurality of conductors that have been twisted together; and
an insulation coating that covers an outer circumference of the plurality of conductors,
wherein the plurality of conductors include:
a plurality of outer conductors that are arranged along an outermost circumference; and
at least one inner conductor that is provided on an inner side of the plurality of outer conductors,
the at least one inner conductor includes one or a plurality of first strands,
the one or more first strands are copper wires, each copper wire including a tin-plating layer,
each of the plurality of outer conductors includes one or a plurality of second strands, and
the one or more second strands are copper wires, each copper wire not including a plating layer.

2. The electric wire according to claim 1, wherein the at least one inner conductor includes the plurality of first strands that have been twisted together, and
each of the plurality of outer conductors includes the plurality of second strands that have been twisted together.

3. The electric wire according to claim 1, wherein the at least one inner conductor includes the one first strand, and
each of the plurality of outer conductors includes the one second strand.

4. The electric wire according to claim 1, wherein the first strands and the second strands have a diameter of 0.30 mm or more.

5. A terminal-equipped electric wire comprising:
the electric wire according to claim 1; and
a terminal that is provided at an end portion of the electric wire.

6. The terminal-equipped electric wire according to claim 5, wherein the terminal is a crimp terminal.

7. The terminal-equipped electric wire according to claim 5, comprising:
a solder portion that is provided at the end portion of the electric wire,
wherein the solder portion is embedded in gaps between the strands at the end portion of the electric wire.
